(19) United States
(12) Patent Application Publication
(10) Pub. No.: US 2021/0276018 A1
(43) Pub. Date: Sep. 9, 2021

(54) DENSE-MEDIUM SEPARATION PROCESS FOR OIL SHALE

(71) Applicant: China University of Mining and Technology, Xuzhou City (CN)

(72) Inventors: Bo Zhang, Xuzhou City (CN); Chenlong Duan, Xuzhou City (CN); Enhui Zhou, Xuzhou City (CN); Guanghui Yan, Xuzhou City (CN); Zengqiang Chen, Xuzhou City (CN); Zhenfu Luo, Xuzhou City (CN); Zhenxing Zhang, Xuzhou City (CN); Guangqing Zhu, Xuzhou City (CN)

(73) Assignee: China University of Mining and Technology, Xuzhou City (CN)

(21) Appl. No.: 17/191,935

(22) Filed: Mar. 4, 2021

(30) Foreign Application Priority Data
Mar. 4, 2020 (CN) 202010144022.0

(51) Int. Cl. B03B 9/02; B07B 1/46; B03C 1/30; B03B 5/34

(52) U.S. Cl. CPC B03B 9/02; B03B 5/34; B03C 1/30; B07B 1/4609

(57) ABSTRACT

Embodiments of the present disclosure provide a pressurized two-product dense-medium separation process for oil shale, and belongs to the field of oil shale industry, in particular to the processing and utilization of oil shale. This process includes: pre-screening a raw oil shale ore through a 25 mm screen; crushing an oversize product, mixing with an undersize product, and separating by a pressurized two-product dense-medium cyclone; and subjecting an underflow and an overflow of the pressurized two-product dense-medium cyclone to dewatering and medium draining respectively to obtain a concentrate and a tailing. The present disclosure has a simple process flow, high separation efficiency and low energy consumption and can reduce the cost of oil refining and achieve better economic benefits.

### CROSS REFERENCE TO RELATED APPLICATIONS

This application claims priority to Chinese Application Serial No. 202010144022.0, filed Mar. 4, 2020, which is herein incorporated by reference in its entirety.

### TECHNICAL FIELD

The present disclosure relates to the field of oil shale separation, in particular to a pressurized two-product dense-medium separation process for oil shale.

### BACKGROUND

Oil shale is an unconventional oil and gas resource, which produces shale oil after thermal processing. As an important raw material for chemical production, shale oil is widely used in the production of various materials. The organic matter of oil shale is decomposed by heat to produce a brown liquid product, which is similar to natural petroleum, but contains more unsaturated hydrocarbons than natural petroleum, and contains non-hydrocarbon organic compounds such as nitrogen, sulfur and oxygen. With the depletion of non-renewable fossil energy sources such as oil, natural gas and coal, the abundant oil shale has been listed as a very important alternative in the 21^{st} century due to its feasibility for development and utilization.

At present, in China's oil shale chemical production and processing, the raw oil shale is simply crushed and screened to a certain size, and the products are directly chemically converted. In this method, a large amount of gangue remains in the raw oil shale, which is unfavorable for subsequent conversion. Therefore, pre-discharging the gangue in the oil shale ore has become a key issue in the processing and utilization of oil shale.

### SUMMARY

In view of the above-mentioned technical deficiency, the present disclosure aims to provide a pressurized two-product dense-medium separation process for oil shale. The present disclosure has simple process flow, high separation efficiency and low energy consumption, and can reduce the cost of oil refining and achieve better economic benefits.

To solve the above technical problem, the present disclosure adopts a technical solution as follows:

the present disclosure provides a pressurized two-product dense-medium separation process for oil shale, which specifically includes the following steps:

a. screening an ore from a mine or storage field by a grading screen, and mixing a selected oil shale ore into a pressurized two-product dense-medium cyclone;

b. subjecting an overflow of the dense-medium cyclone to dewatering and medium draining to obtain an oil shale lump concentrate, a concentrate, a concentrate sludge and a tailing; allowing the concentrate to enter a qualified medium tank and the tailing to enter a concentration tank;

c. subjecting an underflow of the dense-medium cyclone to dewatering and medium draining to obtain a concentrate, oil shale gangue and a tailing; allowing the concentrate to enter the qualified medium tank and the tailing to enter the concentration tank;

d. reusing a qualified medium in the qualified medium tank in steps b and c, and adding an over-dense medium into the qualified medium tank to ensure a concentration of the medium;

e. clarifying the tailings in steps b and c in the concentration tank to obtain clarified water and a concentrated product; and

f. press-filtering the concentrated product in step e into a tailing, and reusing a filtrate and the clarified water as circulating water.

Preferably, in step a, the oil shale ore is screened through a raw ore grading screen with an aperture size of 25 mm; an undersize oil shale ore passing through the grading screen is mixed into the pressurized two-product dense-medium cyclone; an oversize oil shale ore not passing through the grading screen is sent to a crusher through a conveyor belt for crushing, and screened after crushing to complete a processing cycle in turn.

Preferably, in step b, the overflow of the dense-medium cyclone is subjected to dewatering and medium draining through a concentrate arc screen and a concentrate medium-draining screen in turn; an oversize product of the concentrate arc screen enters the concentrate medium-draining screen; an oversize product of the concentrate medium-draining screen enters a concentrate centrifuge to obtain an oil shale lump concentrate and a concentrate sludge; ⅓ of an undersize product of the concentrate arc screen enters the qualified medium tank directly, and the remaining ⅔ of the product enters a concentrate magnetic separator to obtain a concentrate; the concentrate enters the qualified medium tank, and a tailing enters the concentration tank.

Preferably, in step c, the underflow of the dense-medium cyclone is subjected to dewatering and medium draining through a gangue arc screen and a gangue medium-draining screen in turn; an undersize product of the gangue arc screen directly enters the qualified medium tank; an oversize product of the gangue arc screen enters the gangue medium-draining screen; an oversize product of the gangue medium-draining screen is a gangue product; an undersize product of the gangue medium-draining screen enters a gangue magnetic separator; a concentrate obtained by the gangue magnetic separator enters the qualified medium tank, and a tailing enters the concentration tank.

Preferably, the dense-medium cyclone uses high-density ferrosilicon powder as a medium, which is suitable for efficient separation of oil shale.

The present disclosure has the following beneficial effects. By applying the dense-medium separation process to oil shale separation, the present disclosure significantly improves the oil content and gangue discharge effect of the oil shale concentrate, simplifies the oil shale separation process flow, reduces the separation cost, and improves the utilization of the oil shale resource. In addition, the present disclosure is energy-saving and environmentally friendly and has high practicability.

### BRIEF DESCRIPTION OF DRAWINGS

To describe the technical solutions in the embodiments of the present disclosure or in the prior art more clearly, the following briefly describes the accompanying drawings required for describing the embodiments or the prior art. The accompanying drawings in the following description merely show some embodiments of the present disclosure, and a person of ordinary skill in the art may still derive other accompanying drawings from these accompanying drawings without creative efforts.

FIG. 1 shows a flowchart of a pressurized two-product dense-medium separation process for oil shale, according to an embodiment of the present disclosure.

### DETAILED DESCRIPTION

The technical solutions of the embodiments of the present disclosure are clearly and completely described below with reference to the accompanying drawings. The described embodiments are merely a part rather than all of the embodiments of the present disclosure. All other embodiments derived from the embodiments of the present disclosure by a person of ordinary skill in the art without creative efforts should fall within the protection scope of the present disclosure.

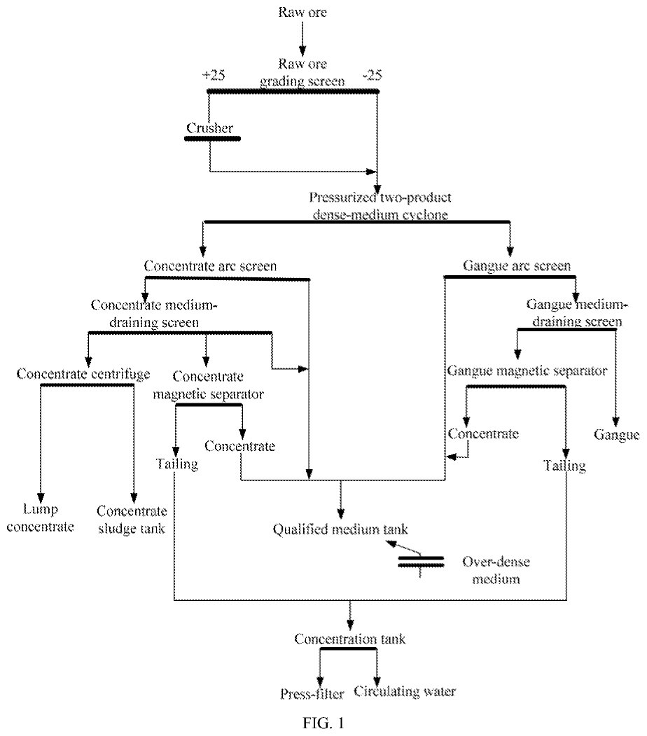

As shown in FIG. 1, embodiments of the present disclosure provide a pressurized two-product dense-medium separation process for oil shale. This process specifically includes the following steps:

a. Screen an ore from a mine or storage field by a grading screen, and mix a selected oil shale ore into a pressurized two-product dense-medium cyclone. Specifically, the oil shale ore is screened through a raw ore grading screen with an aperture size of 25 mm; an undersize oil shale ore passing through the grading screen is mixed into the pressurized two-product dense-medium cyclone; an oversize oil shale ore not passing through the grading screen is sent to a crusher through a conveyor belt for crushing, and screened after crushing to complete a processing cycle in turn.

b. Subject an overflow of the dense-medium cyclone to dewatering and medium draining to obtain an oil shale lump concentrate, a concentrate, a concentrate sludge and a tailing; allow the concentrate to enter a qualified medium tank and the tailing to enter a concentration tank. Specifically, the overflow of the dense-medium cyclone is subjected to dewatering and medium draining through a concentrate arc screen and a concentrate medium-draining screen in turn; an oversize product of the concentrate arc screen enters the concentrate medium-draining screen; an oversize product of the concentrate medium-draining screen enters a concentrate centrifuge to obtain an oil shale lump concentrate and a concentrate sludge; ⅓ of an undersize product of the concentrate arc screen enters the qualified medium tank directly, and the remaining ⅔ of the product enters a concentrate magnetic separator to obtain a concentrate; the concentrate enters the qualified medium tank, and a tailing enters the concentration tank.

c. Subject an underflow of the dense-medium cyclone to dewatering and medium draining to obtain a concentrate, oil shale gangue and a tailing; allow the concentrate to enter the qualified medium tank and the tailing to enter the concentration tank. Specifically, the underflow of the dense-medium cyclone is subjected to dewatering and medium draining through a gangue arc screen and a gangue medium-draining screen in turn; an undersize product of the gangue arc screen directly enters the qualified medium tank; an oversize product of the gangue arc screen enters the gangue medium-draining screen; an oversize product of the gangue medium-draining screen is a gangue product; an undersize product of the gangue medium-draining screen enters a gangue magnetic separator; a concentrate obtained by the gangue magnetic separator enters the qualified medium tank, and a tailing enters the concentration tank.

d. Reuse a qualified medium in the qualified medium tank in steps b and c, and add an over-dense medium into the qualified medium tank to ensure a concentration of the medium.

e. Clarify the tailings in steps b and c in the concentration tank to obtain clarified water and a concentrated product.

f. Press-filter the concentrated product in step e into a tailing, and reuse a filtrate and the clarified water as circulating water.

The dense-medium cyclone uses high-density ferrosilicon powder as a medium, which is suitable for efficient separation of oil shale.

A person skilled in the art can make various modifications and variations to the present disclosure without departing from the spirit and scope of the present disclosure. The present disclosure is intended to cover these modifications and variations provided that they fall within the scope of protection defined by the following claims and their equivalent technologies.

What is claimed is:

1. A pressurized two-product, dense-medium separation process for oil shale comprising the following steps:
screening an ore from a mine or storage field by a grading screen;
mixing a selected oil shale ore into a pressurized two-product dense-medium cyclone;
subjecting an overflow of the dense-medium cyclone to dewatering and medium draining to obtain an oil shale lump concentrate, a concentrate, a concentrate sludge, and a first tailing;
allowing the concentrate to enter a qualified medium tank and the tailing to enter a concentration tank;
subjecting an underflow of the dense-medium cyclone to a second dewatering and medium draining to obtain a second concentrate, oil shale gangue, and a second tailing;
allowing the second concentrate to enter the qualified medium tank and the second tailing to enter the concentration tank;
reusing a qualified medium in the qualified medium tank;
adding an over-dense medium into the qualified medium tank to ensure a concentration level of the medium;
clarifying the first and second tailings in the concentration tank to obtain clarified water and a concentrated product;
press-filtering the concentrated product into a third tailing; and
reusing a filtrate and the clarified water as circulating water.

2. The pressurized two-product dense-medium separation process for oil shale according to claim 1, wherein:
the oil shale ore is screened through a raw ore grading screen comprising an aperture size of 25 mm;
an undersize oil shale ore passing through the grading screen is mixed into the pressurized two-product dense-medium cyclone;
an oversize oil shale ore not passing through the grading screen is sent to a crusher through a conveyor belt for crushing and screened after crushing to complete a processing cycle in turn.

3. The pressurized two-product dense-medium separation process for oil shale according to claim 1, wherein:
the overflow of the dense-medium cyclone is subjected to dewatering and medium draining through a concentrate arc screen and a concentrate medium-draining screen in turn;
an oversize product of the concentrate arc screen enters the concentrate medium-draining screen;
an oversize product of the concentrate medium-draining screen enters a concentrate centrifuge to obtain an oil shale lump concentrate and the concentrate sludge;
⅓ of an undersize product of the concentrate arc screen enters the qualified medium tank directly and ⅔ of the undersize product enters a concentrate magnetic separator to obtain the concentrate;
the first concentrate enters the qualified medium tank; and
the first tailing enters the concentration tank.

4. The pressurized two-product dense-medium separation process for oil shale according to claim 1, wherein:
the underflow of the dense-medium cyclone is subjected to dewatering and medium draining through a gangue arc screen and a gangue medium-draining screen in turn;
an undersize product of the gangue arc screen directly enters the qualified medium tank;
an oversize product of the gangue arc screen enters the gangue medium-draining screen;
an oversize product of the gangue medium-draining screen is a gangue product;
an undersize product of the gangue medium-draining screen enters a gangue magnetic separator;
the second concentrate obtained by the gangue magnetic separator enters the qualified medium tank; and
the second tailing enters the concentration tank.

5. The pressurized two-product dense-medium separation process for oil shale according to claim 1, wherein the medium comprises high-density ferrosilicon powder.
